(19) United States
(12) Patent Application Publication
(10) Pub. No.: US 2024/0361484 A1
(43) Pub. Date: Oct. 31, 2024

(54) PINPOINTER DETECTOR AUTOMATICALLY SWITCHING TO UNDERWATER MODE

(71) Applicant: CONRAD DEDEKTÖR TEKNOLOJILERI VE MÜHENDISLIK HIZMETLERI TICARET LIMITED SIRKETI, Istanbul (TR)

(72) Inventor: EROL GÖKALP, Istanbul (TR)

(21) Appl. No.: 18/645,767

(22) Filed: Apr. 25, 2024

(30) Foreign Application Priority Data
Apr. 25, 2023 (TR) 2023/004518

(51) Int. Cl. G01V 3/165; H01H 13/52

(52) U.S. Cl. CPC G01V 3/165; H01H 13/52; H01H 2223/044; H01H 2231/044

(57) ABSTRACT

The invention is related to the detectors called pinpointer characterized in that it embodies a configuration sensing that it is under water and ensuring that it switches to the underwater mode with no need to user's activity.

### CROSS REFERENCE TO RELATED APPLICATIONS

This application claims priority to Turkish patent application TR 2023/004518, which was filed on Apr. 25, 2023, and which is hereby incorporated by reference as if set forth in its entirety.

### BACKGROUND

The invention is related to the detectors called pinpointer characterized in that it embodies a configuration sensing that it is under water and ensuring that it switches to the underwater mode with no need to user's activity.

Underground scanning devices or detectors with its commonly used name are used in order to detect non-precious metals hidden or embedded underground, precious metals such as gold and silver, underground structures, ancient underground settlements, underground differences or the structure of the ground. They are also used in order to ensure that the data found are processed by transferring the same to the other devices.

Devices called pinpointer are types of detectors too. Pinpointer systems detect the metals by a bobbin. It is easy to use since its size is averagely 25-30 cm and in the shape of a thin cylinder. Its small size and ease of use as part of its structure ensure that it is preferred and used in many challenging areas such as primarily under water.

Pinpointers currently in use are managed by the buttons on the body. Buttons on the device react to the increasing pressure under water. All buttons are pressed at the same time due to pressure and the device is unable to be used.

Certain solutions have been developed with the purpose of eliminating said problem. “Tilt Sensor” has been integrated into some devices. Tilt means slope. In this context, sensors used in order to determine orientation or slope are described as Tilt (Slope) Sensors. Devices equipped with tilt sensor are turned upside down before diving under water and this movement is detected through tilt sensor and underwater mode of the device is activated in line with certain templates (e.g, pressing Button A and Button B at the same time or first, Button A and then, Button B). It is unlikely to say that the present solution is user friendly. It is difficult to understand and implement by the users. Therefore, this affects users' preference of purchasing it adversely.

It is not possible to say that the current solution is user friendly. It is also very difficult to be understood and implemented by the users. Therefore, it negatively affects the purchasing preferences of users.

### SUMMARY

For a solution to the aforementioned problems, pinpointer detector automatically switching to underwater use mode within the scope of the invention has been developed. Once it is under water, device senses this condition and deactivates function buttons with no need to any prior adjustment or user intervention.

Purpose of the invention is to develop pinpointer that can switch to underwater mode by sensing that is it under water.

### BRIEF EXPLANATION OF FIGURES

Pinpointer detector that can automatically switch to the underwater mode developed in order to achieve the purpose of the invention is explained in detail with the figures below:

FIG. 1: It is the perspective view of internal mechanical structure of pinpointer detector.

FIG. 2: It is the top sectional view of pinpointer detector ready for use.

FIG. 3: It is the rear view of pinpointer detector ready for use.

### DESCRIPTION OF PART REFERENCES

Additionally, figures have been divided into parts/sections and explained in detail with their reference numbers:
1. Pinpointer detector
   1.1. Elastomeric material,
   1.2. Activation button,
   1.3. Cover,
   1.4. Water passage hole,
   1.5. Function buttons.

### DETAILED DESCRIPTION OF THE INVENTION

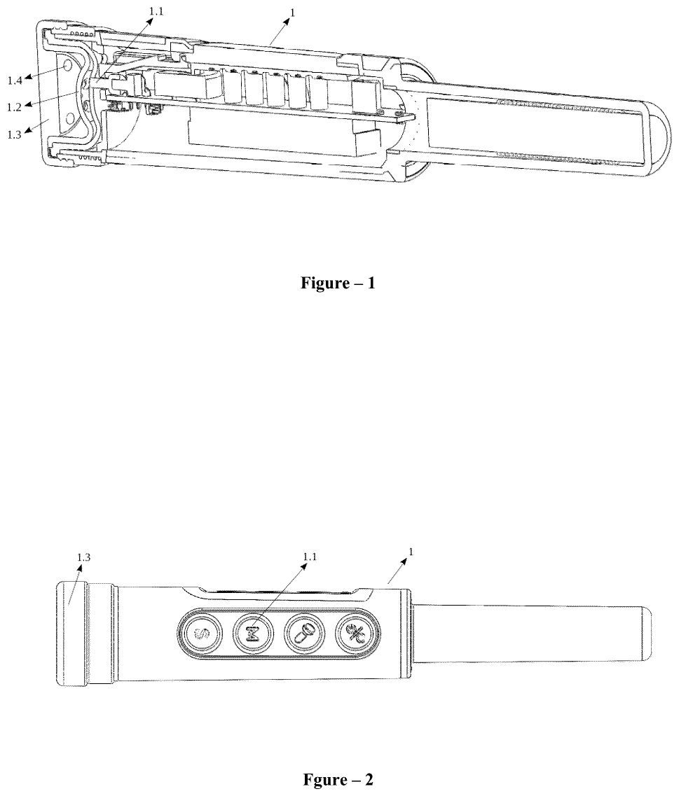

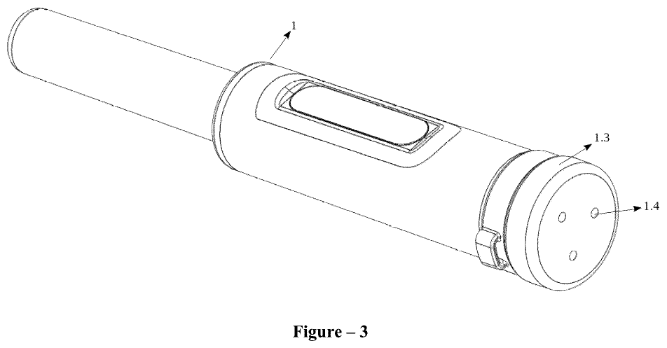

Pinpointer detector that can automatically switch to underwater mode within the scope of the invention has been exemplified in FIG. 1 and FIG. 2.

Based on the figures and reference numbers forming the figures; configuration ensuring automatic detection of switching to underwater mode and deactivation of function buttons on pinpointer detector (1) that can automatically switch to underwater mode is comprised of elastomeric material (1.1), activation button (1.2), cover (1.3), at least one or more water passage holes (1.4) and function buttons (1.5).

There is a simple and effective mechanism on the cover (1.3) part of pinpointer detector (1) within the scope of the invention. Cover (1.3) part has holes. When water comes in thanks to one or more water passage holes (1.4) on the cover (1.3) part, it encounters an elastomeric material (1.1) and exerts pressure on elastomeric material (1.1).

Pressure created by the depth of water ensures that elastomeric material (1.1) exerts pressure on the activation button (1.2) through repelling force it imposes on elastomeric material (1.1). Pressurized activation button (1.2) triggers and starts the system and the device automatically switches to underwater mode. Thus, function buttons are deactivated. User switches to underwater mode from surface without any prior adjustment or process on pinpointer detector.

Activation buttons (1.2) are activated before function buttons (1.5) thanks to pressing force of activation button (1.2) at the back and since elastomeric material (1.1) is more flexible than the function buttons (1.5) on pinpointer detector (1).

Besides, elastomeric material (1.1) increases water impermeability at a significant level through the pressure it exerts on the cover (1.3) due to the pressure under water. Increasing pressure along with the depth causes the air inside to be compressed. In this way, force of external pressure exerted on function buttons (1.5) is balanced and the device can be used in deep waters without switching to underwater mode.

What is claimed is:

1. The invention is related to the pinpointer detector (1) that can automatically switch to underwater mode with no need to make any adjustments by the user by triggering the system with the activation button (1.2) activated by the elastomeric material (1.1) pushed by the pressure force of the water entering through water passage holes (1.4) on the cover (1.3), characterized by comprising of elastomeric material (1.1), activation button (1.2), cover (1.3), water passage hole (1.4) and function buttons (1.5).

2. A pinpointer detector (1) that can automatically switch to underwater mode according to claim 1, and it is characterized in that; it is comprised of an elastomeric material (1.1) exerting pressure on the activation button (1.2) by being pushed with the pressure of the water entering water passage hole (1.4).

3. A pinpointer detector (1) that can automatically switch to underwater mode according to claim 1, and it is characterized in that; it is comprised of activation button (1.2) triggering the system by being activated with the pressure exerted by elastomeric material (1.1) pushed with the pressure of the water entering water passage hole (1.4).

4. A pinpointer detector (1) that can automatically switch to underwater mode according to claim 1, and it is characterized in that; it is comprised of cover (1.3) having water passage hole (1.4) allowing entry of the water, the pressure of which elastomeric material (1.1) exerting pressure on activation button (1.2) will be exposed to.

5. A pinpointer detector (1) that can automatically switch to underwater mode according to claim 1, and it is characterized in that; it is comprised of water passage hole (1.4) through which water exposing elastomeric material (1.1) exerting pressure on activation button (1.2) to pressure can enter.

6. A pinpointer detector (1) that can automatically switch to underwater mode according to claim 1, and it is characterized in that; it is comprised of function buttons (1.5) that are used for management of the system and deactivated by the system that is triggered by the activation button (1.2).

7. An elastomeric material (1.1) according to claim 1, wherein it is comprised of more flexible structure than function buttons (1.5) in order to start the system by being affected from pressure of water earlier.

8. An activation button (1.2) according to claim 7, wherein its pressing force is more flexible than function buttons (1.5) in order to start the system by being affected from pressure of water earlier.

9. A water passage hole (1.4) according to claim 8, wherein there are preferably one or more holes.

10. An elastomeric material (1.1) according to claim 2, wherein it is comprised of more flexible structure than function buttons (1.5) in order to start the system by being affected from pressure of water earlier.

11. An activation button (1.2) according to claim 10, wherein its pressing force is more flexible than function buttons (1.5) in order to start the system by being affected from pressure of water earlier.

12. A water passage hole (1.4) according to claim 11, wherein there are preferably one or more holes.

13. An elastomeric material (1.1) according to claim 3, wherein it is comprised of more flexible structure than function buttons (1.5) in order to start the system by being affected from pressure of water earlier.

14. An activation button (1.2) according to claim 13, wherein its pressing force is more flexible than function buttons (1.5) in order to start the system by being affected from pressure of water earlier.

15. A water passage hole (1.4) according to claim 14, wherein there are preferably one or more holes.

16. An elastomeric material (1.1) according to claim 4, wherein it is comprised of more flexible structure than function buttons (1.5) in order to start the system by being affected from pressure of water earlier.

17. An activation button (1.2) according to claim 16, wherein its pressing force is more flexible than function buttons (1.5) in order to start the system by being affected from pressure of water earlier.

18. A water passage hole (1.4) according to claim 17, wherein there are preferably one or more holes.

19. An elastomeric material (1.1) according to claim 5, wherein it is comprised of more flexible structure than function buttons (1.5) in order to start the system by being affected from pressure of water earlier.

20. An activation button (1.2) according to claim 19, wherein its pressing force is more flexible than function buttons (1.5) in order to start the system by being affected from pressure of water earlier.
